(19) United States
(12) Patent Application Publication
(10) Pub. No.: US 2024/0391659 A1
(43) Pub. Date: Nov. 28, 2024

(54) CONTAINER PROVIDED FOR A LIQUID OR VISCOUS SUBSTANCE AND EQUIPPED WITH A VALVE

(71) Applicants: THE USE FACTORY, Cairon (FR); PRP CREATION, Oyonnax (FR)

(72) Inventors: Jean-Yves Corbin, Le Fresnes Camilly (FR); Mathias D'Estais, Caen (FR)

(73) Assignees: THE USE FACTORY, Cairon (FR); PRP CREATION, Oyonnax (FR)

(21) Appl. No.: 18/694,277

(22) PCT Filed: Sep. 23, 2022
(86) PCT No.: PCT/EP2022/076598

§ 371 Date: Mar. 21, 2024

(30) Foreign Application Priority Data
Sep. 23, 2021 (FR) FR2110055

(51) Int. Cl. B65D 47/20; B05B 11/00

(52) U.S. Cl. CPC B65D 47/2018; B05B 11/007; B05B 11/0072

(57) ABSTRACT

A container may include a wall and an outlet valve, where the outlet valve includes: a membrane that is elastically deformable under the effect of positive pressure of a substance relative to the outside, an outer surface of the membrane being in contact with an external environment, in the area of a slit formed in a zone for removing the substance, the slit being suitable for allowing the discharge of a flow of the substance caused by the positive pressure; a wall configured to be, in the absence of positive pressure of the substance, in contact with an inner surface of the membrane along a contact line arranged on the periphery of the slit, and configured to allow the inner surface of the membrane to move away from at least part of the wall in the event of positive pressure of the substance.

### TECHNICAL FIELD OF THE INVENTION

The invention relates to containers equipped with valves and/or pumps and that can be used for liquid or viscous substances, in particular pharmaceutical or cosmetic substances, agri-food substances, or do-it-yourself substances.

### PRIOR ART

U.S. Pat. No. 8,875,953 (Reference 1) discloses a pump that can be operated manually or via a utensil held in one hand by a user.

FIG. 1 thus describes the operating principle of a pump according to the teachings of Reference 1 applied to a jar 11.

The pump illustrated in FIG. 1 comprises a chamber 10 the inside of which is suitable for containing a liquid or viscous substance and the outside of which is intended to be placed in contact with an external environment, for example air, in the area of a slit 17 formed in a removal zone 13, and placed in contact with a replacement fluid 18, in the area of an opening 16 made in the chamber. In the example in FIG. 1, a strip 15 forms a partition between the chamber 10 and a reservoir 14 formed by a flexible bag in fluidic communication with the chamber through the opening 16. The reservoir is protected by the walls of the jar 11 provided with an air inlet 12.

The chamber 10 is elastically deformable by pressing by a user, to create, for example by sliding the finger in a direction F, positive pressure in the substance relative to the outside and open the slit 17 in order to let out a useful volume of substance. As illustrated in diagram 1B, the chamber 10 is thus divided into two deformed parts 101 and 102, the part 101 comprising the slit 17 and the part 102 comprising the opening 16. By sliding the pinch along the chamber in the direction F, the substance is compressed under the pinch and discharged through the slit 17 and simultaneously the part 102 of the chamber 10 gradually resumes its shape, generating negative pressure that admits replacement substance through the opening 16. When the finger leaves the removal zone 13, the chamber resumes its initial shape as it was at rest (diagram 1A). The return to the initial shape takes place through shape memory, that is, the capacity of the chamber to elastically resume its shape after deformation of the material of the deformable zone.

Generally, the region of the deformable membrane equipped with the slit forms an outlet valve referred to hereinafter as a “split membrane”.

In the pump thus described, the negative pressure created at the moment when pressing ceases is capable of admitting a volume of replacement substance into the chamber. This negative pressure can be quite significant, thus drawing the split membrane inward until an opening of the slit is created in the opposite direction to the intended direction, which causes liquid to return toward the inside of the chamber and/or air to be taken into the chamber. This phenomenon is observed particularly when the liquid is quite viscous. The ingress of air into the chamber can cause splashes and unpleasant noises on subsequent uses, and the ingress of air and the ingress of liquid from the outside into the chamber can cause retrocontamination of the container, that is, dirt or bacteria present on the surface of the jar, in the air, on a user's finger, or on a utensil, can end up in the chamber, develop therein and potentially reach the container.

Deformation toward the inside and opening of the slit comparable to that described above can also result from mechanical pressure due to direct stress applied to the zone for example by a finger, a utensil, or more generally an external element, for example the skin of the body when the device is used for direct application. This phenomenon does not result from negative pressure on the inside, but from positive pressure or action from the outside, but the outcome is similar. It will be noted here that the two phenomena can be combined, as removal from the removal surface logically takes place after liquid has been extracted, therefore precisely at the moment when the chamber is placed under negative pressure to draw liquid from the reservoir.

In order to limit such deformation of the membrane toward the inside of the chamber, Reference 1 discloses a supporting part 103 (FIG. 1) forming a solid piece or a grille on which all or part of the slit rests in the absence of deformation of the slit. Such a supporting part holds back the deformation of the slit or one side of the slit toward the inside of the chamber so that it acts against any loss of sealing caused by a geometric deformation of the membrane toward the inside of the chamber. The supporting part, if it is correctly positioned, can act positively by keeping the slit in its nominal position even when it is subject to stress. It must be noted that the supporting part, whether a grille or solid, is described as a surface on which all of part of the slit rests, that is, its aim is not to act directly on sealing, but to place the slit in the correct position so that the edges of the slit are in a situation in which they create the seal themselves. Because the supporting part can be pierced and even in the form of a grille, the membrane does not adhere to the supporting part even if the liquid slowly dries out. If the supporting part has a small surface area or is a grille, this allows the slit to rest and ensures prompt detachment.

In other words, the supporting part does not strengthen the sealing of the device but allows the slit to be in a favorable situation more often, the sealing being due to the slit itself, with one edge of the slit being in contact with the other edge of the slit.

More specifically, the applicant has highlighted a number of limitations relating to the use of such a supporting part.

Firstly, in order for the two edges of the slit to meet and make contact with each other, it is important that the split membrane or split valve returns to its natural place after opening, that is, without residual tension, in order to obtain the sealing thereof.

The local influence of the supporting part on the slit thus introduces a mechanical contradiction, as the supporting part creates stress that inevitably influences the movements of the slit and sometimes generates failures, that is, the slit remains stuck at a position that is not completely flat and contiguous. Such a situation is frequent because the membrane is made from flexible materials the geometry and internal tensions of which are uncertain. It has thus been noted that the positioning of such a supporting part under the slit is difficult to adjust and inevitably transfers tension to the slit itself, limiting its capacity to return to a natural sealed position in the static state.

Next, the applicant has noted that a local support under all or part of the slit can be counterproductive as, faced with significant negative pressure upstream of the slit or external local pressure, the membrane is depressed in the unsupported zones. As the depression thus occurs on either side of the slit, this depression inevitably results in the separation of the edges of the slit, which immediately weakens its seal. It will thus be noted that in the absence of the supporting part, the tolerance for depression is much greater, that is, negative pressure in the chamber can generate a movement of the split membrane without the slit opening, and conversely, the same negative pressure with a supporting part under the slit can separate the edges of the slit and allow air or soiled liquid in.

As a result, the applicant has shown that the advantages of such a supporting part are limited, its positioning is difficult and its use is in many cases counterproductive.

Users therefore desire improved performance, and in particular a very high level of sealing and therefore barrier effect against dirt and bacteria to limit retrocontamination, particularly through the slit of the outlet valve.

In particular, the applicant has noted that the membrane, whether or not it is provided with a supporting part under the slit as described above, can undergo loss of sealing in the presence of negative pressure upstream of the membrane, but without inward deformation thereof.

A first situation can be observed on a pump outlet valve as described above. As described above, on each pumping action a phase of negative pressure is observed in the chamber of the pump upstream of the slit. Such negative pressure is capable of causing liquid to migrate from the slit toward the inside, even in the absence of inward deformation of the membrane. The greater this phenomenon or the more it is repeated, the more migrations are favored. The consequences of this phenomenon are generally unacceptable, in particular for a cosmetic device intended to deliver a small dose of cream directly onto the skin or removed with the finger. The same applies to most other applications of these pump outlet valves. If the designer places a supporting part under the slit, as described above, this can limit the opening of the membrane toward the inside, but such a supporting part is not sufficient to prevent liquid from passing inward through the membrane and therefore to prevent fungi, dirt or bacteria from developing in the channel.

A second situation can be observed on a package provided with a pump opening to an outlet channel the end of which is closed by a split membrane; this situation can generate a similar phenomenon. The package can be for example a bottle equipped with a conventional piston pump or an electric pump. Such a bottle is described for example in U.S. Pat. No. 5,186,368 (Reference 2).

Whether it is a conventional piston pump or an electric pump, the pump does not generally form the actual outlet of the package and therefore opens toward an outlet channel that emerges into an outlet or removal zone. So that the liquid contained in the outlet channel does not degrade, designers often place a valve, which can be a split membrane, at the end of this channel. Although there are fewer occurrences of negative pressure in the channel than in an outlet pump design as described in the situation above, this design can also result in substance returning toward the inside, particularly when the user passes a finger or a utensil over the membrane, in particular to remove liquid. If the designer places a supporting part under the slit, this can limit the opening of the membrane inward, but such a supporting part would probably not prevent liquid from passing inward through the membrane and therefore not prevent fungi, dirt, or bacteria from developing in the channel.

Another situation can be observed on a flexible package outlet valve having a degree of shape memory and not equipped with a pump, for example simple plastic tubes as described for example in GB1474620 (Reference 3).

The valves described are beneficial barriers when they are located at the end of the tube, as they provide real protection for the entire contents of the tube. On such a tube and apart from during the steps for use in which it is pressurized to extract substance, the tube seeks to return to a natural shape, which causes a degree of negative pressure in the tube that is transferred in particular to the membrane. This negative pressure is greater the closer one comes to the end of the tube. Again, it could be envisaged to prevent the membrane from deforming inward by positioning a supporting part therein in order to better withstand the negative pressure present in the tube, which could be sufficient to open the valve inward, but such a device would remain subject to leaks and migrations causing retrocontamination, especially in this situation of a tube in which the negative pressure can be significant and maintained continuously for a long time.

A first possible response by a person skilled in the art to the technical problems set out above consists of using antifungal and antibacterial chemicals so that retrocontamination has no consequences and cannot develop in the liquid but, due to the pressure of standardization and the demands of the market, manufacturers are increasingly realizing that preservatives and antifungals must be reduced as far as possible.

Another means available to a person skilled in the art consists of improving sealing by providing a greater thickness and/or greater stiffness of the split membrane and/or a shorter slit. By changing these parameters, the membrane will be more responsive and quicker to close, and will have improved cohesion of the two facing edges or sides of the slit. Such a membrane will thus be more resistant to retrocontamination.

An elastomer with hardness of 70 Shore A can for example be chosen for the material of the membrane rather than an elastomer with a hardness of 50 Shore A, or the thickness of the membrane can be increased around the slit, for example by replacing a membrane initially dimensioned at 0.8 mm with a membrane with a thickness of 1.2 mm, or a slit measuring 3 mm instead of 4 mm can be cut, etc.

Finally, although it is not directly within the remit of the packaging designer, the viscosity of the substance can be changed, as a more viscous substance will have a direct impact on improving sealing.

Nevertheless, changing one or more of the parameters mentioned above generally results in valve with reduced throughput, which leads to undesirable effects and in particular a lack of comfort in the use of this type of valve. For a device that can be operated by hand, a greater thickness and/or a greater stiffness of the membrane and/or a shorter slit for example increase the effort required of the user, which in some configurations can very significantly interfere with the capacity of the device to deliver substance with a simple, acceptable action.

It must be noted here that the issue of user comfort is highly significant. Users do not appreciate operating a pump, for example on a bottle, with significant force. For a tube, on which the outlet orifice is usually simply a hole, it is even more unacceptable to create a very strong outlet valve and thus require the user to supply significant effort in order to obtain liquid. The market clearly expects a reduction in the pressure required to deliver a dose, while increasing sealing, which is the opposite of the result of the approach that a person skilled in the art could take.

In addition, whether for a device that can be operated by hand (pump or direct pressure packaging such as a tube) or by means of a motorized pump, the stiffness of the membrane creates during use an increase in the positive pressure upstream of the slit which, when it reaches the level sufficient to open the slit (opening threshold) then triggers a pressure-relief effect. This pressure-relief effect is unpleasant during use and should be as discreet as possible. If it becomes too great due to the increase in the thickness or stiffness of the membrane, or due to the reduction in the size of the slit, or due to the increase in the viscosity of the substance, this can cause liquid splashing that is generally perceived very negatively as it causes surprise or even accidents.

Finally, it will be noted that by choosing a thicker and/or stiffer membrane and/or a shorter slit and/or greater viscosity of the substance, for packages equipped with a pump upstream of an outlet valve, whether the pump is a conventional mechanical pump or a motorized pump, the increase in the threshold of the outlet valve means that the package is often left after use when the outlet channel is still subject to internal positive pressure. This situation is necessarily likely to trigger small leaks when the package is left unused. Although this is not a contamination problem in this instance, it is still a significant secondary problem and equally unacceptable.

One aim of the present description is to propose a new outlet valve having increased reliability, particularly in terms of sealing, while retaining satisfactory user comfort.

### SUMMARY OF THE INVENTION

In the present description, the term “comprise” means the same as “include” and “contain”, and is inclusive or open and does not exclude other elements not described or shown. Further, in the present description, the term “approximately” or “substantially” means the same as “having a margin of less and/or greater than 10%, for example 5%”, of the respective value.

According to a first aspect, the present description relates to a container intended to receive a liquid or viscous substance, said container comprising a wall and an outlet valve, said outlet valve comprising:
a membrane arranged in the wall of the container, the membrane being elastically deformable under the effect of positive pressure of the substance relative to the outside, an outer surface of the membrane being in contact with an external environment, for example air, in the area of at least one first slit formed in a substance removal zone, said at least one first slit being suitable for allowing the discharge of a flow of said substance caused by said positive pressure,
at least one first wall configured to be, in the absence of positive pressure of the substance, in contact with an inner surface of the membrane along at least one first contact line arranged on the periphery of said at least one first slit, and configured to allow said inner surface of the membrane to move away from at least part of said at least one first wall in the case of positive pressure of the substance, said at least one first contact line forming, in the absence of positive pressure of the substance, at least one first linear sealing zone.

In a container according to the present description, the positive pressure of the substance relative to the outside is generated by a user pressing, for example on a pressing zone. Pressing by a user can be direct pressing, for example pressing generated by the user's hand, or indirect pressing, for example pressing generated by means of a utensil held by the user.

An external environment is understood to be an environment outside the container. The substance removal zone is a zone accessible to a user, for removing the substance. The substance can be removed from the removal zone for example by means of a finger, a utensil, or more generally by the surface of an external element, for example the skin of the body when the device is used for direct application.

In the outlet valve according to the first aspect, said at least one first contact line formed by said at least one first wall is arranged on the periphery of the slit, that is, it does not intersect the slit. Said at least one first wall thus arranged on the periphery of the slit creates, in the absence of positive pressure of the substance, a linear sealing zone upstream of the slit. Said at least one first wall is passed by the substance via the only deformation under pressure of the membrane forming the outlet valve, the contact line thus being broken.

Compared to a supporting part as disclosed in the prior art, the linear sealing zone thus formed allows more reliable sealing of the outlet valve.

Firstly, in the absence of overpressure of the substance, the seal is greatly increased from the outside to the inside, that is, when pressure is applied to the membrane from the outside (for example, the situation in which a finger presses on the membrane with a drop of liquid trapped under the finger), the membrane withstands this better as the pressure is transferred to a contact line and not to a surface. With a supporting part as described in the prior art, in particular when it covers the entire surface of the slit, the pressure applied to the membrane is distributed over the entire surface of the supporting part. As has been seen, this configuration can facilitate the separation of the sides of the slit but above all there is no reliable sealing line and the liquid can intrude between the surfaces of the supporting part and the membrane, even if the supporting part is solid. Conversely, by creating, according to the present description, a linear seal, any pressure experienced by the membrane on the line automatically results in stronger sealing, as any dirt is restricted to the volume of liquid confined downstream of the sealing line.

It must be noted that in order for the linear seal to be effective, the contact line must simply be formed on the periphery of the slit. The topography of the space under the slit is relatively unimportant. It can be a volume with a significant height, for example having the length of the slit as its height, or a very small volume, for example having a height of the order of 0.1 millimeter, or any height between these two values. What is important is the existence of linear contact between upstream and downstream.

In addition, the sealing benefit described here with pressure is very similar in a situation of negative pressure upstream of the valve. Whether it is a tube or any other configuration, the negative pressure will draw the membrane inward and press the membrane onto said at least one first wall and thus strengthen the seal.

Further, by avoiding locating the part in contact with said at least one wall in the area of the slit but rather situating it on the periphery, no negative deformation is caused on the slit itself, which is conducive to the sealing and reliability of the slit. By freeing the underside of the slit of a local support as described in the prior art, the slit is allowed to return to its relaxed position completely naturally, that is, without stressing it in any way, and improvements are thus observed in the quality of the closure and therefore of the seal.

Finally, an outlet valve according to the first aspect makes it possible to strengthen the seal without however detracting from user comfort, as an increase in the force necessary to open the slit formed in the membrane is not necessary.

Provision can even be made for a membrane with a freer slit, made for example in a more flexible or thinner membrane, or a longer slit, which would make this valve a valve that can be opened with less effort, while being assured of a very good level of sealing, and also able to withstand both internal negative pressure, even sustained, and pressure from the outside.

According to one or more exemplary embodiments, said at least one first wall comprises an edge in contact with said inner surface of the membrane in the absence of positive pressure of the substance to form said at least one first contact line. Such exemplary embodiments can be selected to increase the reliability of the sealing line without complicating the design.

According to one or more embodiments, the membrane further comprises at least one first protuberance extending from the inner surface of said membrane, said at least one first wall being, in the absence of positive pressure of the substance, in contact with said at least one first protuberance to form said at least one first contact line.

Sealing can then result from the compression of the protuberance against the wall and/or the positioning of the protuberance relative to the wall. Such exemplary embodiments are suitable for example for having great responsiveness of the sealing line and/or great resistance to positive pressure of the volume downstream of the sealing line and/or negative pressure upstream. Such an example is suitable for increasing the reliability of the seal when closed as the sealing line can be very fine and tolerant to potentially imprecise positioning of the membrane.

Of course, a protuberance on the membrane and an edge on the first wall can for example be combined in order to optimize the behavior of the membrane and in particular the seal.

According to one or more exemplary embodiments, said at least one first contact line formed by said at least one first wall in the absence of positive pressure of the substance is a closed contact line that can surround or not said at least one first slit.

For example, a closed contact line that surrounds said at least one first slit makes it possible to apply significant pressure to the contact line without however risking the creation of negative deformation on the slit.

According to one or more exemplary embodiments, the closed contact line surrounds said at least one first slit and describes a peripheral line at a distance from the slit, for example in the shape of an oval or an ellipse. For example, the contact line is distant by at least 50% of the length of the slit at all points. For example, an ellipse of 10 mm×8 mm can surround a slit 4 mm long.

Such a closed contact line can be obtained in various ways, but these examples are non-limiting.

According to one or more exemplary embodiments, such a closed contact line is obtained with said at least one first wall comprising an edge in contact with the inner surface of the membrane, in the absence of positive pressure of the substance, for example an edge of a circular or oval wall.

In other exemplary embodiments, said at least one first wall can be formed by a cylinder ending level with the inner surface of the membrane. In this case, an upper face of the cylinder can be substantially planar and said inner surface of the membrane can be substantially concave. The closed contact line is then obtained by the edge present on the perimeter of the upper face of the cylinder, in contact with the inner surface of the membrane, in the absence of positive pressure of the substance.

In other exemplary embodiments, said upper face of the cylinder can be slightly concave, in which case said inner surface of the membrane can be substantially planar. Again, this configuration makes it possible for the contact between the upper face of the cylinder and the inner surface of the membrane to be limited to the edge line of the upper face of the cylinder and to avoid contact between the upper face of the cylinder and the inner surface of the membrane, so that the linear sealing zone is real and active.

Of course, a contact line limited to the edge line of the upper face of the cylinder can be obtained with other configurations. What is important is for the concavity, or more generally the shape, of the upper face of the cylinder and the inner face of the membrane to form a slight space under the membrane to produce the phenomenon of linear sealing on the periphery of the upper face of the cylinder.

According to one or more exemplary embodiments, the membrane further comprises at least one first protuberance extending from the inner surface of the membrane, for example substantially toric, and said closed contact line is obtained with said at least one first wall being, in the absence of positive pressure of the substance, in contact with said at least one first protuberance. For example, said at least one first wall comprises a substantially planar plate.

According to one or more embodiments, said outlet valve further comprises at least one duct for conveying the substance into a closed volume in immediate proximity to the membrane comprising said at least one slit, said duct comprising at least one end.

Said at least one first wall can then be formed by said at least one end of said duct for conveying the liquid, said at least one end forming a contact line with the inner surface of the membrane in the absence of positive pressure of the substance and moving away from said inner surface in the event of positive pressure of the substance, thus letting the substance enter the under-membrane volume.

According to one or more embodiments, said at least one end of said at least one duct for conveying the substance comprises an edge forming the contact line with the inner surface of the chamber.

According to one or more exemplary embodiments, the membrane further comprises at least one first protuberance extending from the inner surface of the membrane, for example in the form of a stud, said at least one protuberance being configured to shut off said at least one end of said at least one duct for conveying the substance to form said contact line. A toric seal is thus obtained that results from the positioning of the protuberance relative to the wall.

According to one or more exemplary embodiments, the outlet valve comprises a duct for conveying the substance with a plurality of ends, for example a plurality of ends emerging into a closed volume in immediate proximity to the membrane comprising said at least one slit. According to one or more exemplary embodiments, the outlet valve can comprise a plurality of ducts for conveying one or more substances.

In the exemplary embodiments described above, the contact line formed by the wall in the absence of positive pressure of the substance is also a closed contact line, but it does not necessarily surround the slit. In such examples, contact is sought that causes little deformation of the slit around the membrane. If the design is asymmetrical, care will be taken to ensure that the contact between the membrane and said at least one wall is sufficiently slight so that it does not generate stress; likewise, the contact line can for example be moved away from the slit to limit the deformation caused, for example being situated at a distance at least equal to 150% of the length of the slit.

Another way consists of positioning the contact line directly in line with the slit, on either side or at just one of the ends. These locations are beneficial as even by applying a degree of pressure of the conveying duct or ducts to the membrane, this pressure results in a slight tension on the slit that in no way detracts from its ability to close in a contiguous and sealed manner.

Of course, the exemplary embodiments of said at least one first contact line are not limited to those described above.

According to one or more exemplary embodiments, said at least one wall can thus form an unclosed contact line in the absence of positive pressure of the substance, for example a contact line forming a straight-line segment or a curved segment; for example, said at least one wall forms a partition joining the walls of the container and thus creating a divider between a conveying duct and the closed volume in immediate proximity to the membrane comprising said at least one slit.

In addition, the outlet valve according to the first aspect can comprise a plurality of walls each forming a contact line with the inner surface of the membrane in the absence of positive pressure of the substance. For example, one contact line can surround said at least one slit while another contact line can be offset upstream, for example at the end of a conveying duct.

Another example is a first contact line that surrounds said at least one slit while another contact line can be offset upstream surrounding said first contact line.

What is notable is that this combination of solutions strengthens the seal but still does not impair use, as when pressure is exerted upstream of the contact lines, the membrane lifts and the two barriers become free. The force to be exerted by the user is then entirely similar with or without the presence of these strengthened seals.

According to one or more embodiments, the outlet valve according to the first aspect comprises a plurality of slits. A plurality of slits makes it possible to ensure faster delivery of the substance for the user.

According to one or more exemplary embodiments, the outlet valve further comprises at least one duct for conveying the substance into a closed volume in immediate proximity to the membrane comprising said at least one slit. The slits of the plurality of slits can then be arranged on the outline of a region of the membrane situated in the area of said closed volume, said region comprising at its center a protuberance extending from the inner surface of the membrane, said protuberance being configured to be inserted into the duct for conveying the substance so that in the absence of positive pressure of the substance, a contact line is formed with one end of the duct for conveying the substance, while in the event of positive pressure of the substance, said protuberance moves away from at least part of said end, letting the substance enter said under-membrane volume. Said end of the duct for conveying the substance thus forms said at least one wall of the outlet valve according to the first aspect.

According to one or more exemplary embodiments, said region has a geometric shape with one or more axes of symmetry. For example, four slits can be arranged on the outline of a square region, or, more generally, slits can be arranged on the sides of a polygonal region.

Said at least one slit within the meaning of the present description is a simple slit, that is, a cut made in the membrane for example using a fine blade and therefore without cutting away material. This technique statistically allows the slit to close as soon as it is no longer subject to any pressure and to create a good level of sealing in itself.

For example, a length of the slit is between approximately 3 mm and approximately 7 mm.

According to one or more embodiments, the slit is flared toward the inside of the membrane, making its lips non-contiguous on the inner surface of the membrane. A bevel is thus formed on the inner surface of the membrane on either side of the slit, for example in the shape of an upturned U or an upturned V. Such a bevel makes it possible to facilitate the opening of the slit without however losing sealing.

According to one or more embodiments, the container further comprises a pump. For example, this can be an electric pump, for example a peristaltic pump, or a pump that can be activated manually, for example a pump comprising a plunger and a rigid actuator. In other exemplary embodiments, the outlet valve of the container according to the first aspect can itself be incorporated at the outlet of a pump intended to receive a liquid or viscous substance.

According to one or more embodiments, the container according to the first aspect further comprises:
a chamber comprising an inner volume suitable for containing the substance, said membrane of the outlet valve forming one wall of the chamber,
an opening allowing the admission into the inner volume of the chamber of a volume of replacement liquid following the cessation of pressing by the user;
wherein the assembly comprising said outlet valve, the chamber, and the opening forms a pump that can be operated by the pressing by the user.

A pump as described with an outlet valve according to the first aspect makes it possible to generate a reduction in the volume of the chamber in order to allow the discharge of the desired dose of substance, then the suction of a replacement volume, while ensuring excellent sealing.

According to one or more embodiments, said pump comprises a first sub-assembly comprising said outlet valve, a second sub-assembly comprising the opening formed in the chamber, and a channel configured to connect said first and second sub-assemblies.

According to one or more embodiments, the second sub-assembly is configured to form a pressing zone for a user, the positive pressure of the substance relative to the outside being generated by the user pressing on the pressing zone.

According to one or more embodiments, said channel splits into at least two branches emerging into the chamber in the area of said first sub-assembly, on either side of said at least one slit. Such a configuration can allow improved distribution around the slit of the substance that emerges from the channel in the event of pressure exerted by a user on the pressing zone. In this example, a linear sealing zone can for example be formed around each end of each branch of the channel emerging into the chamber and/or around the slit.

According to one or more embodiments, the container further comprises a reservoir of said liquid or viscous substance, said reservoir being fluidically connected to said chamber by means of said opening. For example, the reservoir is deformable or provided with an air inlet.

### BRIEF DESCRIPTION OF THE FIGURES

Further advantages and features of the invention will become apparent on reading the description, illustrated by the following figures:

FIG. 1 shows a diagram of a jar equipped with a pump according to the prior art (already described);

FIG. 2A shows cross-sectional diagrams of outlet valves according to the present description, according to various exemplary embodiments;

FIG. 2B shows further cross-sectional diagrams of outlet valves according to the present description, according to various exemplary embodiments;

FIG. 2C shows further cross-sectional diagrams of outlet valves according to the present description, according to various exemplary embodiments;

FIG. 3 shows cross-sectional diagrams and a top view of an outlet valve according to the present description, according to another exemplary embodiment;

FIG. 4A shows cross-sectional diagrams of an example of a tube-type container, equipped with an outlet valve according to one example according to the present description;

FIG. 4B shows cross-sectional diagrams of another example of a tube-type container, equipped with an outlet valve according to one example according to the present description;

FIG. 4C shows a cross-sectional diagram of an example of a bottle-type container, equipped with an outlet valve according to one example according to the present description, and a pump according to a conventional design;

FIG. 5A shows cross-sectional diagrams and a top view of an example of a jar-type container, equipped with pump according to the present description;

FIG. 5B shows cross-sectional diagrams illustrating the operation of the pump described in FIG. 5A;

FIG. 5C shows cross-sectional diagrams and a top view of an example of a jar-type container similar to the one in FIG. 5A, equipped with another example of a valve according to the present description;

FIG. 5D shows a cross-sectional diagram of an example of ajar-type container similar to the one in FIG. 5A, equipped with another example of a valve according to the present description;

FIG. 6 shows a cross-sectional diagram illustrating an example of another jar-type container equipped with a pump according to the present description, equipped with a valve of the type illustrated in FIG. 3.

### DETAILED DESCRIPTION OF THE INVENTION

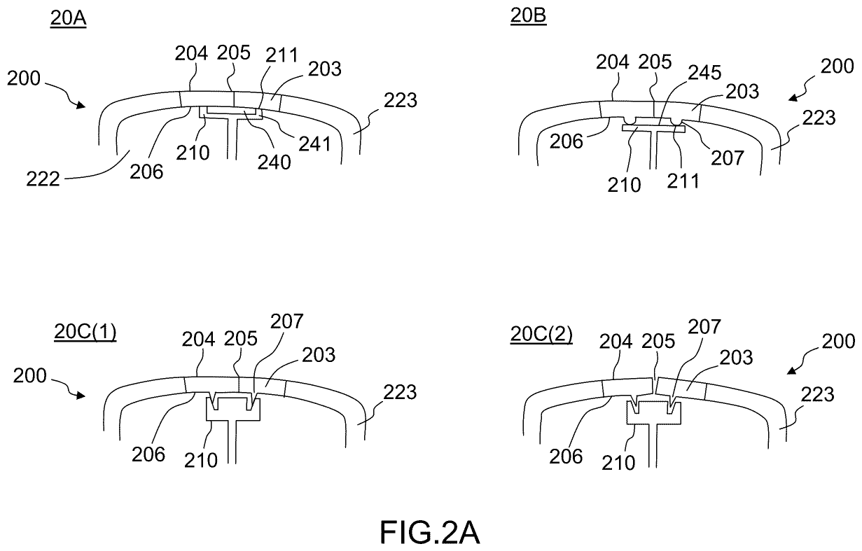

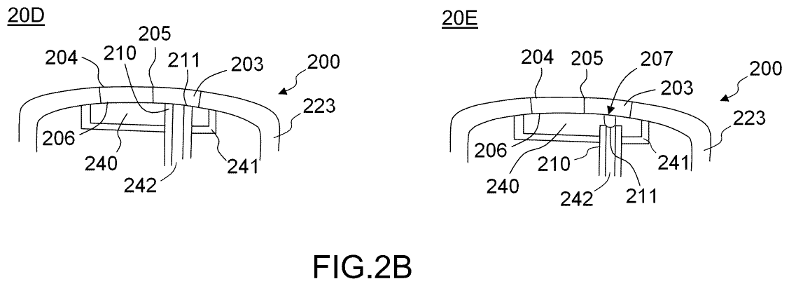

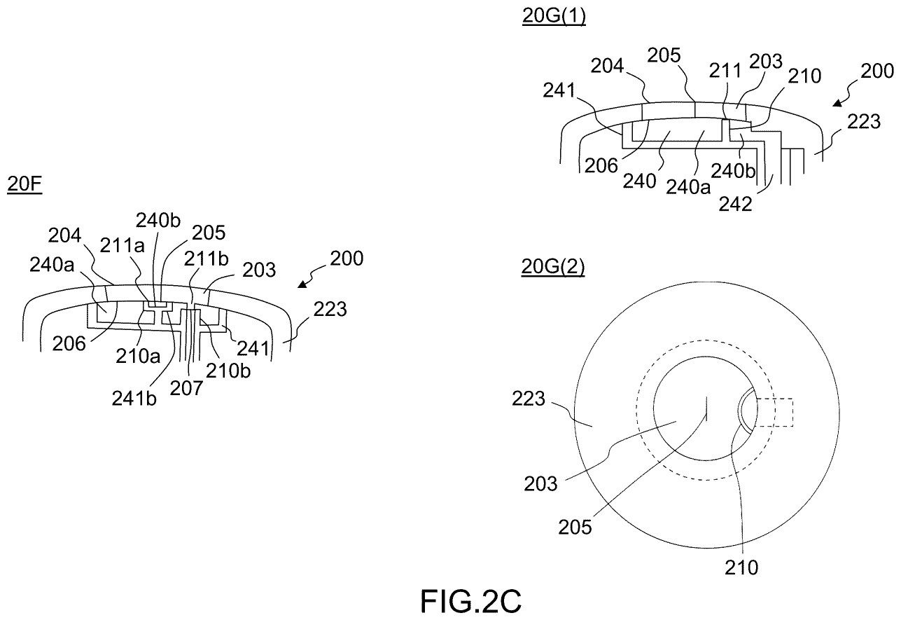

FIGS. 2A, 2B, and 2C each show a plurality of cross-sectional diagrams of outlet valves 200 according to the present description, according to various exemplary embodiments.

The outlet valve 200 generally comprises a membrane 203 arranged in a wall 223 of a container (not shown) intended to receive a liquid or viscous substance 222. The membrane 203 is elastically deformable under the effect of positive pressure of the substance relative to the outside, for example under the effect of pressing by a user.

In the examples illustrated in the figures, the membrane comprises an inner surface 206 and an outer surface 204 in contact with air in the area of a slit 205 suitable for allowing the discharge of a flow of the substance caused by the positive pressure.

The physical deformation phenomena that allow the expulsion of the substance are described in particular in Reference 1 cited above. A lifting or general swelling movement of the deformable membrane 203 is observed on pressurization. This swelling is explained by the fact that the outlet valve is split, or pierced without removal of material; the skin is therefore generally sealed under negative pressure and provides resistance before opening, i.e. before delivery. Swelling is thus the first effect of the pressurization of the substance upstream of the valve. Swelling occurs when the volume upstream of the membrane is pressurized, that is, in a compression chamber of a pump as will be described below, or in a volume downstream of a conventional pump, or in a reservoir that forms the chamber and that can be pressurized directly by the user.

In any case, the geometry of the swelling observed depends on features of the slit and on the geometry of the membrane and the material used.

A lifting of the membrane 203 will thus be observed in valves as illustrated in FIGS. 2A, 2B, and 2C. With the start of this lifting, the lips or edges of the slit 205, which are in contact at rest, will be slightly tensioned, the tension occurring in particular in the direction of the slit itself. Initially, this phenomenon tends to make the outlet valve more resistant, but conversely, the lips of the slit will then be gradually separated following this lifting until substance is discharged.

In order to strengthen the seal of the outlet valve thus described without however increasing the force necessary to open the valve (for example by greater stiffness of the material forming the membrane, or by a shorter slit, or by a thicker membrane), the applicant has designed an outlet valve further comprising at least one first wall on the periphery of the slit, which wall the substance will pass simply by the deformation under pressure of the membrane according to the lifting described above.

The outlet valve 200 according to the present description thus further comprises at least one first wall 210 configured to be, at rest, that is in the absence of positive pressure of the substance, in contact with the inner surface 206 of the membrane along at least one first contact line 211 arranged on the periphery of the slit 205, and configured to move away from said inner surface in the event of positive pressure of the substance causing the lifting of the membrane. The contact line 211 thus forms, at rest, a linear sealing zone upstream of the slit 205.

The diagrams shown in FIGS. 2A to 2C thus illustrate different exemplary embodiments of one or more walls aimed at strengthening the seal, but these examples are non-limiting.

In the examples shown in diagrams 20A, 20D, 20F, 20G, a contact line 211 is obtained with a wall 210 comprising an edge in contact with the inner surface 206 of the membrane, in the absence of positive pressure of the substance.

For example (diagrams 20A, 20F), the wall (211, 211a) can form, in the absence of positive pressure of the substance, a closed volume 240 or “pool” in proximity to the membrane in which the slit is located. The contact line 211 forming the linear sealing zone is in this case a closed contact line that surrounds the slit, which allows an additional effect of strengthening the slit. A similar effect can be obtained with a wall (not shown) comprising a planar or slightly concave plate, which is only in contact with the inner surface of the membrane along an edge and not over the entire surface of the plate, in order to form the linear sealing zone. Here, the pool is very small but retains its functions. It also further stabilizes the slit against depression, particularly under the action of a finger, a nail, or a utensil. A shallow pool is thus a beneficial solution. It will be understood that this result can be obtained with such a slightly concave disk shape under a planar membrane, but it can also be obtained in other configurations. For example, a convex plate in the shape of a portion of a sphere with a radius of 6 mm can be topped by a membrane with an inner radius of 5 mm and form a space under the membrane and linear sealing on contact. What is important is that the radii of curvature of the plate and the membrane form a slight space between the membrane and the plate to produce the linear sealing phenomenon.

In these configurations, a plate can be located just under the membrane, which mechanically prevents the slit from being depressed. This solution differs from the prior art in that the plate covers a large surface area and is not reduced to the zone under the slit, and in that, at rest in the absence of pressure, the support is in contact with the membrane not on its surface under the slit but on its edge, allowing linear sealing on the periphery of the slit.

In the examples shown in diagrams 20D, 20E, 20F, and 20G, the outlet valve further comprises a duct (242) for conveying the substance. In diagrams 20D and 20F, the wall 210 is formed in these examples by said one end of said duct for conveying the liquid, said end comprising an edge forming the contact line 211 with the inner surface of the membrane in the absence of positive pressure of the substance and moving away from said inner surface in the event of positive pressure of the substance, thus letting the substance enter the space in proximity to the membrane. In these examples, the contact line 211 also forms a closed line but that does not surround the slit. It will be noted that unlike in the design illustrate here to facilitate the legibility of the figures, the designer will preferably opt to position the duct 210 (diagram 20D) and the duct 210B (diagram 20F) directly in line with the slit. This makes it possible to avoid tension on mounting, or action on the membrane from outside, or the passage of fluid through the channel, creating a deformation in the area of the slit that might shift or disjoint the sides. The more asymmetrical the channel is relative to the slit, the greater the risk of this phenomenon. By situating the duct in the continuation of the slit instead, these various potential deformations will result in a slight tension of the slit and prevent the undesirable passage of fluid.

In the example in diagrams 20G(1), 20G(2) (a cross-sectional view and a top view respectively), the outlet valve comprises, as in the example in diagram 20D, a fixed pool 241 forming an under-membrane volume and a duct 242 for conveying the substance into said volume. However, in this example, the wall is not formed by one end of the duct. In this example, the wall is formed by a partition 210 that creates a division in said space between a downstream region (240a) and an upstream region (240b). As the partition 210 is in contact with the deformable membrane 203 in the absence of positive pressure in the chamber, the same linear sealing phenomenon occurs here. This configuration, which is very similar to 20D, nonetheless makes it possible to simplify the design and slightly limit the volume of material. It will be noted that in this example, the contact line 211 forms an unclosed line in the absence of positive pressure of the substance, here a curved segment.

In the examples illustrated in diagrams 20B, 20C(1), 20C(2), 20E, 20F, the membrane comprises a protuberance 207 that extends from the inner surface of the membrane. The protuberance is for example substantially toric (20B) or in the form of a pin (20E, 20F). A contact line (210, 210b) is obtained in the absence of positive pressure of the substance, by means of a wall (211, 211b) in contact with the protuberance.

For example (diagram 20B), the wall 210 comprises a substantially planar plate. In the example illustrated by means of diagrams 20C(1) and 20C(2) (outlet valve at rest and with positive pressure), the protuberance 207 is formed by a lip molded on the membrane and that provides a seal that has been selected here to be conical, with the conical wall 210.

In the example in diagram 20E, the outlet valve comprises, as in the example in diagram 20D, a fixed pool 241 forming an under-membrane volume and a duct 242 for conveying the substance into said volume; in this example, the wall 210 is formed by the end of the duct. The protuberance 207 in the form of a stud is configured to shut off the duct in the absence of positive pressure of the substance in said duct and thus create the contact line 211 to form the linear sealing zone.

As illustrated in diagram 20F, the outlet valve can comprise a plurality of walls each forming a contact line with the inner surface of the membrane in the absence of positive pressure of the substance. In this example, one contact line can surround said at least one slit while another contact line can be offset upstream, further strengthening the seal. Two successive sealing fronts are thus created without however impairing use. Another combination allowing multiple sealing fronts is the creation of walls peripheral to the slit, organized so that they are nested, that is, a first line surrounds the slit, in turn surrounded by a second line, and optionally others.

Whichever example is described, the wall 210 in the outlet valve according to the present description makes it possible to segment a volume in proximity to the membrane into two regions, a region downstream of the wall, in proximity to the membrane in which the slit is located, and a region upstream of the wall.

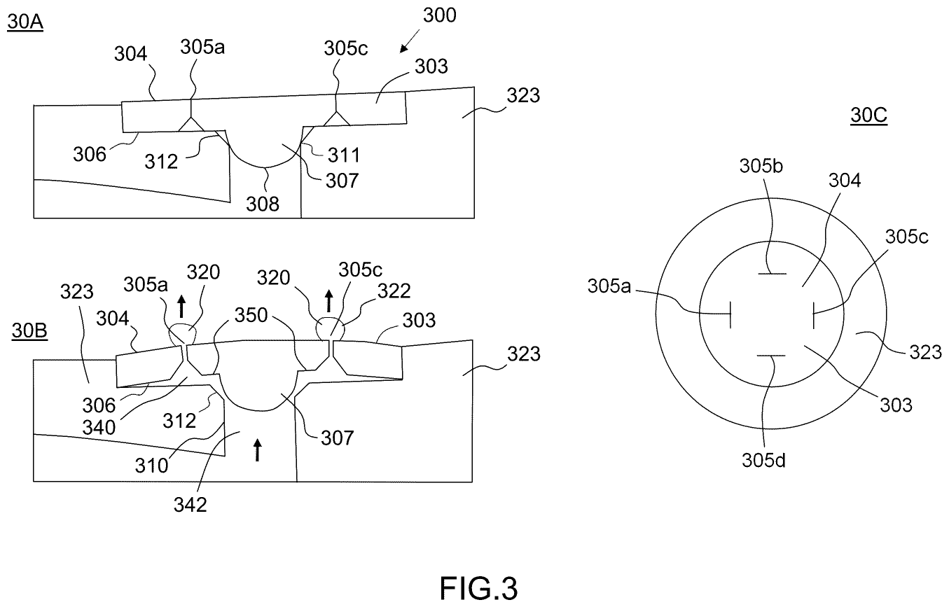

FIG. 3 shows cross-sectional diagrams (30A and 30B) and a top view (30C) of an outlet valve 300 according to the present description, comprising a plurality of slits. Diagrams 30A and 30B illustrate the outlet valve 300 at rest and during operation. In this example, as above, the outlet valve 300 comprises a membrane 303 arranged in a wall 323 of a container (not shown) intended to receive a liquid or viscous substance 320. The membrane 303 is elastically deformable under the effect of positive pressure of the substance relative to the outside, for example under the effect of pressing by a user. In the example illustrated in FIG. 3, the membrane comprises an inner surface 306 and an outer surface 304 in contact with air in the area of a plurality of slits, in this example four slits 305a, 305b, 305c, 305d, suitable for allowing the discharge of a flow of the substance caused by the positive pressure.

The outlet valve 300 further comprises a closed volume 340, in immediate proximity to the membrane comprising the slit, and a duct 342 for conveying the substance 320 into said volume. In this example, the closed volume is obtained by a cavity formed in the wall 323 of the container. The slits of the plurality of slits are arranged on the outline of a region of the membrane 303 situated in the area of said volume, said region of the membrane comprising at its center a protuberance 307 in the form of a stud, extending from the inner surface 306 of the membrane. The protuberance is configured to be inserted into the duct 342 for conveying the substance so that in the absence of positive pressure of the substance, a contact line 311 is formed with one end 310 of the duct for conveying the substance, while in the event of positive pressure of the substance, said protuberance moves away from said end, letting the substance enter the under-membrane volume 340. Said end 310 of the duct for conveying the substance thus forms said at least one wall of the outlet valve according to the present description. More specifically in this example, the protuberance 307 is generally hemispherical and is bordered by an annular flat segment 350 forming a shoulder configured to rest on a planar wall of the cavity formed in the wall 323 of the container. In this example, the cylindrical wall 310 comprises an annular bevel 312. At rest (diagram 30A), the protuberance 307 rests in this case on an edge of the bevel 312 or on a portion of the bevel 312, which makes it possible to generate the contact line 311. During operation (diagram 30B), the substance 320 set in motion by means of positive pressure—exerted for example by a user—that is exerted on the surface 308 and causes the protuberance 307 to lift, breaks the linear sealing zone formed by the contact line 311, which then exerts a force distributed over the entire membrane 303 and causes the swelling of the entire membrane until the opening of the slits is generated, which allows the substance to exit to the outside.

Placing a sealing line 311 upstream of the membrane, as illustrated in this figure, has an impact on the behavior of the four slits, and is already a major operational benefit. In this example, it can however be seen that the lower surface 306 of the membrane 303 is in planar contact with a portion of the planar wall of the cavity formed in the wall 323 of the container. This plane-on-plane contact at rest is not very favorable as it does not make it possible to create a linear seal in this location and is also at risk of sticking if the liquid dries out. The quality of the seal of the slits and of the linear seal 311 already in place contribute to overcoming these secondary problems. Then, sticking can be avoided by limiting the plane-on-plane contact by means of small projections under the membrane and/or on the portion of the planar wall of the cavity formed in the wall 323 of the container. Provision can then be made to leave a slight space under the membrane, for example between approximately 0.2 mm and approximately 0.5 mm. Finally, in addition to the first sealing line, another level of sealing and security can be added by providing a second sealing line between the first sealing line 311 and each outlet slit. To this end, a sealing line formed by a localized protrusion on the periphery of the slits is added between the wall 323 of the container and the planar part of the membrane, on the inner face 306 of the membrane 303, or on the wall 323. This protrusion can be a single protrusion for the four slits and it will for example be located near the top of the bevel 312. It can also be specific to each slit and positioned around each slit to encircle it according to a design of the type in 20A, that is, belonging to the wall 323, or of the type in 20B, that is, belonging to the membrane. It will be remembered here that placing a second sealing line in the path of the liquid in this way further strengthens the seal and does not significantly impair use.

In the example in FIG. 3, four slits are arranged on the outline of a square region. More generally, the slits of the plurality of slits, for example between two and six, can be arranged on the sides of a region having a geometric shape with one or more axes of symmetry, for example a polygonal region.

In an outlet valve according to the present description, in particular an outlet valve as illustrated in the examples described above, a membrane can be used with a thickness of approximately 0.8 to 2.5 mm, molded from a material with a hardness of approximately 30 to 80 Shore A, and slits between 1.5 and 5 mm long can be made.

This type of end piece is in particular suitable for direct application to the body. Of course, the examples illustrated by means of the diagrams in FIGS. 2A to 2C and FIG. 3 are non-limiting. In order to achieve the desired effect, namely the formation of the linear sealing zone in the absence of positive pressure of the substance, upstream of the slit, the designer has all of the parameters of the slit and its environment, namely the arrangement of the various elements forming the outlet valve, the properties inherent in the materials, in particular the hardness of the materials forming the membrane and said at least one wall, the thickness of the membrane, the dimensions of the slit and of the pre-slit bevel, and the surface of the membrane free to deform around the slit; routine tests then make it possible to optimize the outlet valve according to the present description through simple operations.

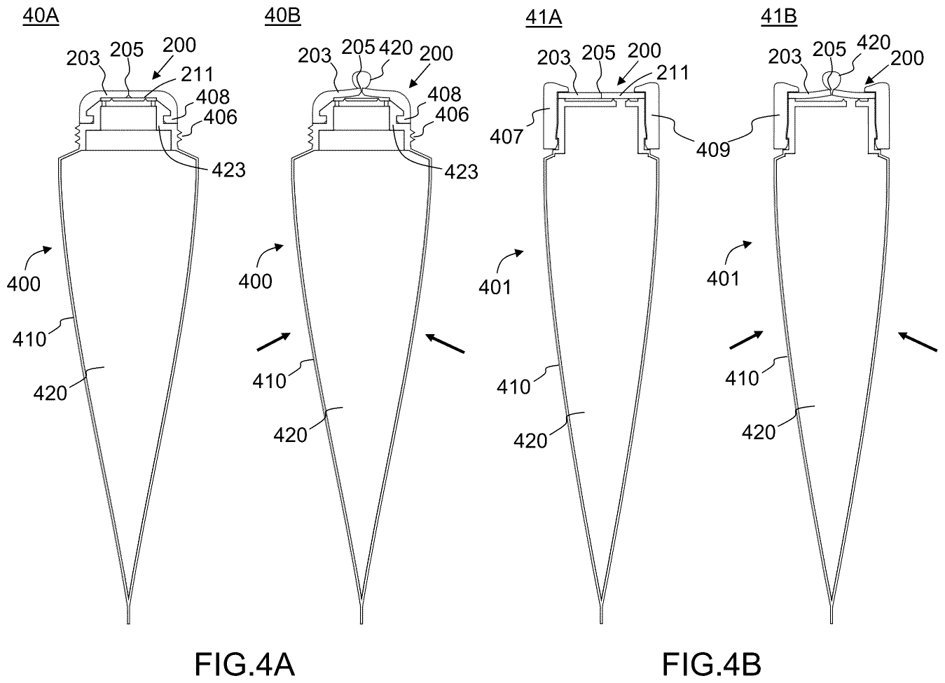

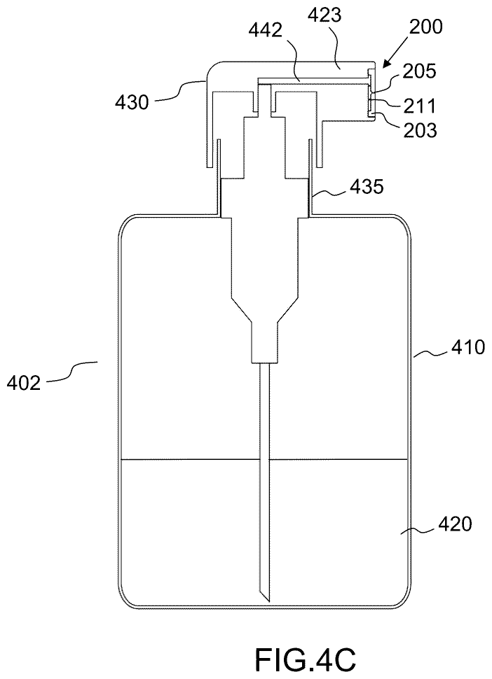

FIGS. 4A to 4C, FIGS. 5A to 5C, and FIG. 6 illustrate applications of outlet valves according to the present description to different containers. The applications described are however non-limiting, and the outlet valve according to the present description can apply generally to containers intended to receive liquid or viscous substances, for example pharmaceutical or cosmetic substances, agri-food substances, or do-it-yourself substances. In addition, the features described in relation to the various examples of containers can be combined, for example a valve described for a tube can be mounted on a pump for example.

FIG. 4A shows cross-sectional diagrams of a tube-type container 400 equipped with an outlet valve 200 according to the present description mounted directly on a tube or reservoir 410. In this example, the outlet valve 200 is mounted by anchor points 408 on a wall 423 of the container. The container 400 also comprises a thread 406 configured to receive a cap (not shown).

Diagrams 40A and 40B illustrate the container 40 with the outlet valve 200 at rest and during operation. During operation, a user exerts pressure directly on the tube 410 (illustrated by arrows in diagram 40B), allowing the discharge of the substance 420 through the outlet valve 200. In this example, the outlet valve 200 generally comprises a membrane 203 arranged in the wall 423 of the container, the membrane being elastically deformable under the effect of positive pressure of the substance 420 contained in the tube 410. An outer surface of the membrane is placed in contact with air in the area of one or more slits 205 suitable for allowing the discharge of a flow of said substance caused by said positive pressure.

In this example, the slit or slits of the membrane 203 are exposed to stress for example by a finger, a utensil, or more generally the surface of an external element, for example the skin of the body when the device is used for direct application. In these designs not equipped with a pump, the membrane is subject to little negative pressure on removal, however, the tube 410 always seeks to resume a natural shape, which generates a degree of negative pressure on the membrane 203 between removals. This negative pressure grows increasingly as the end of the tube is approached, until it significant levels of negative pressure are reached. Whether at the start of the tube or the end of the tube, retrocontamination is always unacceptable, in particular for cosmetics, but in addition to this, a tube that takes in a potentially significant amount air impairs use, as pressure does not make it possible to provide the expected volume of substance.

The outlet valve 200 thus comprises at least one first wall configured to be, in the absence of positive pressure of the substance, in contact with an inner surface of the membrane along at least one first contact line arranged on the periphery of the slit, and configured to move away from said inner surface in the event of positive pressure of the substance. The contact line thus forms a linear sealing zone in the absence of positive pressure of the substance.

In FIG. 4A, the outlet valve is not shown in its entirety so that the figures are not cluttered. In particular, the walls intended to form the contact lines in the absence of positive pressure of the substance are not shown. Only the linear sealing zone that results from the presence of the wall is schematically shown and denoted by the general reference sign 211. In the example in FIG. 4A, the linear sealing zone surrounds the slit and the substance arrives from the periphery. However, all of the embodiments of the walls described in the present description for the formation of the linear sealing zones can be implemented, and in particular the examples described with reference to FIGS. 2A to 2C and FIG. 3.

FIG. 4B shows cross-sectional diagrams (41A, 41B) of another tube-type container 401 equipped with an outlet valve 200 according to the present description mounted directly on a tube or reservoir 410. The tube is substantially similar to the tube in FIG. 4A, with the exception that, in this example, the outlet valve 200 comprises a disk of split elastically deformable material forming the membrane 203 trapped in a headless cap 409. This design makes it possible for the flexible membrane to be made for example from a split elastomeric pellet, or molded, or cut from a sheet of elastomer. In this example, the linear sealing zone 211 is arranged around a cylindrical supply channel communicating with the reservoir 410 but again, all of the embodiments of the walls described in the present description for the formation of the linear sealing zones can be implemented, and in particular the examples described with reference to FIGS. 2A to 2C and FIG. 3.

In the examples in FIGS. 4A, 4B, the outlet valves are mounted directly on tubes, without pumps.

The present description also applies to containers equipped with pumps according to a conventional design (piston pump or motorized pump).

FIG. 4C thus shows an example of a pump-bottle type container 402, comprising a bottle ending in a neck, consisting of a reservoir 410 filled with liquid or viscous substance 420, equipped with a conventional piston pump component 435 common in the cosmetic industry and the end of which is extended by an outlet channel ending in a valve according to the invention. Here, the valve is of the type shown in 20D or 4B, but could be selected from the valves shown in FIGS. 2A to 2C or FIG. 3. In these configurations, it is beneficial that the valve can be traversed at very low pressure of the substance, as it avoids leaving said outlet channel under positive pressure and thus limits leaks of liquid between two uses.

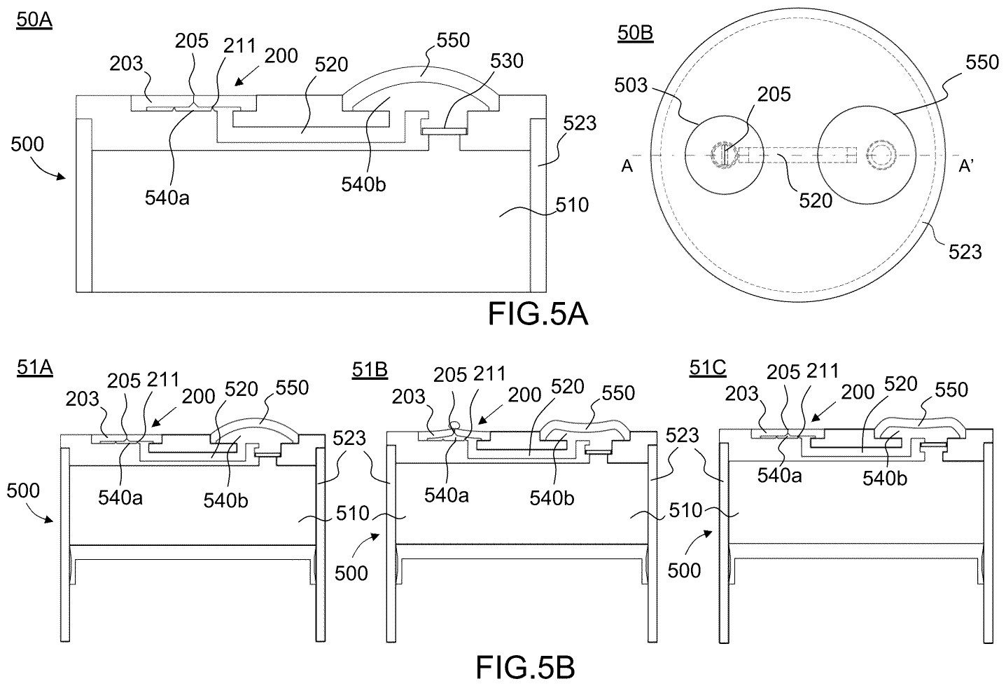

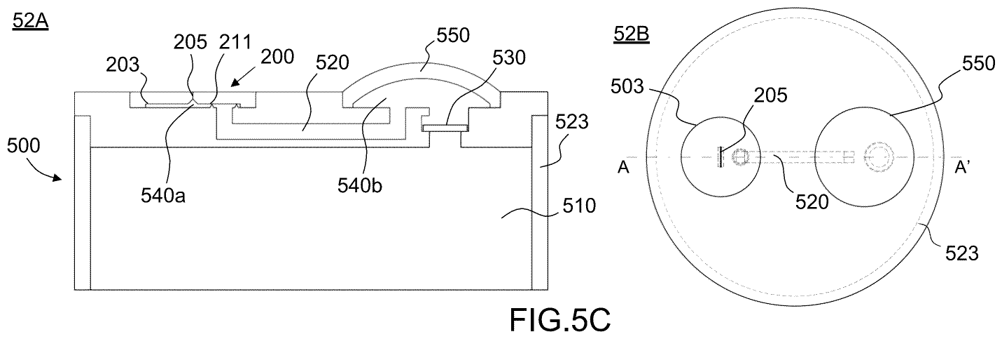

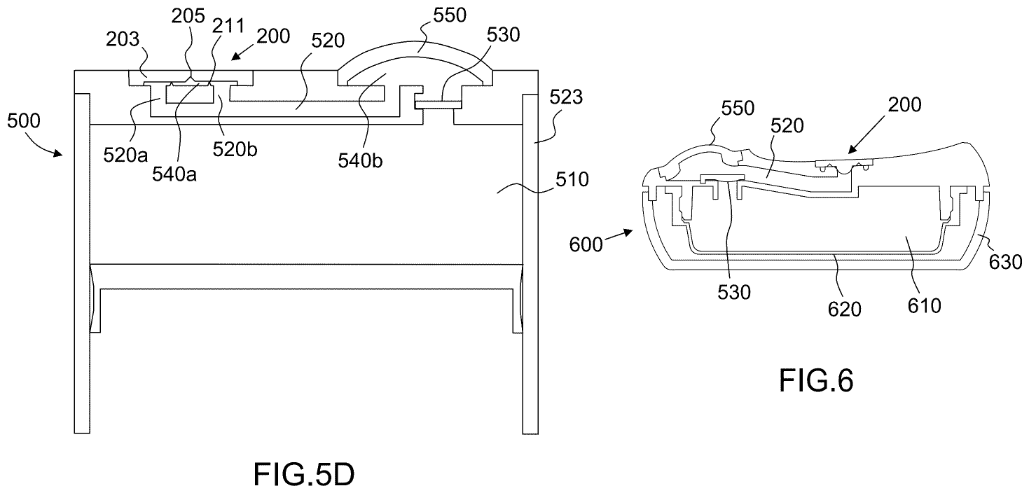

FIGS. 5A, 5B, 5C, 5D and FIG. 6 illustrate pump applications with an outlet valve according to the present description, suitable for “jar” type containers used for example for cosmetic applications.

FIG. 5A thus shows a cross-sectional diagram (50A) and a top view (50B) of an example of a container 500, comprising a pump equipped with an output valve 200 according to the present description. FIG. 5B diagrammatically shows the operation of the pump in a container as illustrated in FIG. 5A. FIG. 5C shows a cross-sectional diagram (52A) and a top view (52B) of a variant of the container shown in FIGS. 5A and 5B, and FIG. 5D shows another variant. In these diagrams, the outlet valve is not shown in its entirety so that the figures are not cluttered. In particular, the walls intended to form the contact lines in the absence of positive pressure of the substance are not shown. However, the linear sealing zones that result from the presence of the walls are shown diagrammatically and denoted by the general reference sign 211, it being understood that unless stated otherwise, all of the embodiments of the walls described in the present description for the formation of the linear sealing zones can be implemented, and in particular the examples described with reference to the diagrams in FIGS. 2A, 2B, 2C, FIG. 3, and FIGS. 4A, 4B, 4C.

The pump shown in the figures can be operated by pressing by a user or by a utensil held by a user, and comprises an outlet valve 200 according to the present description, a chamber 540 comprising an inner volume suitable for containing the substance, and an opening allowing the admission into the inner volume of the chamber of a volume of replacement substance following the cessation of pressing by the user. The outlet valve generally comprises a membrane 203 arranged in a wall 523 of the container, the membrane being elastically deformable under the effect of positive pressure of a substance. An outer surface of the membrane is placed in contact with air in the area of one or more slits 205 suitable for allowing the discharge of a flow of said substance caused by said positive pressure and the membrane 203 of the outlet valve forms a wall of the chamber.

In the examples illustrated by means of FIGS. 5A to 5D, the chamber comprises a first sub-assembly 540a comprising the outlet valve 200, and a second sub-assembly 540b comprising the opening formed in the chamber. The chamber further comprises a channel 520 for connecting the first and second sub-assemblies sealably against the substance, the air and the replacement substance. In these examples, the second sub-assembly of the chamber also comprises a pressing zone 550 for a user, in the form of a “bubble”.

In these examples, the opening emerges into a substance reservoir 510. For example, as illustrated in FIG. 5B, the jar comprises a lower movable plate that tends to rise as the substance is consumed and that interacts with the sides of the jar to form the reservoir.

More specifically in these examples, the opening is a flexible valve formed by a hole in the chamber 540 (optionally) covered with a flap 530 suitable for covering the hole hermetically against said substance, in the presence of positive pressure downstream of said flap, and suitable for allowing substance to circulate through the hole under the effect of negative pressure downstream of said flap.

In these examples, the outlet valve 200 comprises at least one first wall (not shown) configured to be, in the absence of positive pressure of the substance, in contact with an inner surface of the membrane along at least one first contact line arranged on the periphery of the slit, and configured to allow said inner surface to move away from the wall in the event of positive pressure of the substance. At least one linear sealing zone 211 is thus formed.

In the example in FIG. 5A, the linear sealing zone 211 is a closed line that surrounds the slit. Such a linear sealing zone can for example be obtained by one and/or another of the exemplary embodiments described with reference to diagrams 20A, 20B, 20C, 20D of FIG. 2A, but these examples are non-limiting.

As illustrated in diagrams 51A to 51C of FIG. 5B, at rest (diagram 50A), that is in the absence of positive pressure in the substance, the outlet valve is closed, together with the valve formed by the hole in the chamber and by the flap 530. The linear sealing zone 511 is therefore formed around the slit, preventing any risk of retrocontamination upstream of the wall forming said sealing zone 511. When positive pressure is caused in the chamber 540 by the user pressing on the bubble 550 (diagram 51B), substance is discharged from the second sub-assembly of the chamber to the first sub-assembly of the chamber through the channel 520. The contact line is broken, allowing the substance to reach the membrane and be discharged through the slit 205. At the end of the stress, when the positive pressure ceases (diagram 51C), the bubble 550 tends to resume its initial shape, producing a suction effect that lifts the flap 530, opening the valve and allowing the replacement liquid to reach the chamber. The linear sealing zone 511 is restored.

In the example in FIG. 5C, the linear sealing zone 211 is a closed line that surrounds one end of the channel 520 emerging into the chamber in the area of the first sub-assembly. Such a linear sealing zone can for example be obtained by one and/or another of the exemplary embodiments described with reference to diagrams 20D, 20E of FIG. 2B, or FIGS. 20G(1) and 20G(2), or FIG. 4B, but these examples are non-limiting. In addition, it is possible to simultaneously provide a linear sealing zone around the end of the channel and a linear sealing zone around the slit, as illustrated for example in diagram 20F of FIG. 2C.

FIG. 5D shows ajar similar to the jar in FIGS. 5A, 5B, or 5C, but wherein the channel splits into at least two branches 520a, 520b emerging into the chamber in the area of said first sub-assembly, on either side of the slit 205. Such a configuration can allow improved distribution around the slit of the substance that emerges from the channel 520 in the event of pressure exerted by a user on the pressing zone 550.

In this example, a linear sealing zone can for example be formed around each end of each branch of the channel emerging into the chamber and/or around the slit. Such a configuration can also be equipped with two or even more independent conveying ducts, potentially supplied by independent reservoirs and making it possible to thus mix the liquids directly under the membrane, beyond the sealing line. Configurations of the type shown in 5D, but also 20D, 20E, 20F, 20G(1), 20G(2), 4B, 4C, 5C, and 5D are by their nature suitable for this.

It will be noted that in all of the examples of configurations disclosed, there can be independent reservoirs that emerge into and feed a single outlet valve, the inlets coming together if applicable upstream of the valve.

Although not illustrated in FIGS. 5A to 5D, outlet valves of the type shown in diagrams 20G(1) and 20G(2) of FIG. 2C or in FIG. 3, or in FIG. 4B, are also possible for the jar-type container described in these figures. Valves of the type shown in 20D, 20E, 20F are also possible.

FIG. 6 shows a cross-sectional view of another jar-type container 600 equipped with an example of a pump according to the present description. The container 600 is generally similar to the jar shown in FIG. 5B or 5D. In this example, the reservoir 690 is for example a deformable flexible bag configured to deform as the substance is consumed so as to adapt to the quantities of remaining substance. In this example, an outlet valve similar to the one shown in FIG. 3 is illustrated. Of course, other outlet valves according to the present description are possible.

The present description is not limited to the applications described with reference to FIGS. 5 and 6, and other applications are possible for a pump according to the present description.

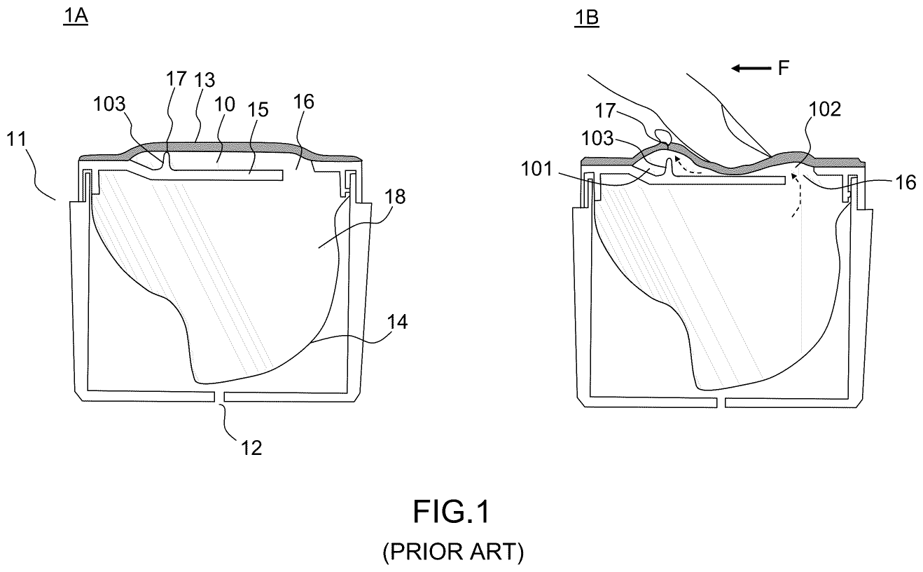

For example, a pump according to the present description can be arranged on a jar-type container as illustrated in FIG. 1 with a strip forming a partition between the chamber and a reservoir formed for example by a flexible bag in fluidic communication with the chamber through an opening. The pump can then be equipped with an outlet valve according to the present description, for example but non-limitingly an outlet valve according to one of the exemplary embodiments described with reference to diagrams 20A, 20B, 20G of FIGS. 2A and 2C, FIG. 3, and FIGS. 5A to 5D.

Generally, the figures illustrating tubes represent all types of direct pressure packaging.

Generally, the figures showing the valves to which the present patent relates as pump outlet valves can be transposed or at least adapted to direct pressure packaging outlet valves. Likewise, the figures showing the valves to which the present patent relates as direct pressure packaging valves can also be transposed to packaging with pumps.

More generally, again, each outlet valve solution described can be transposed to all of the types of packaging mentioned. Some configurations can be less user-friendly, or more complex to implement, or in less demand on the market, but in principle this remains true.

Although described by means of a number of exemplary embodiments, the outlet valves according to the present description, the pumps equipped with such outlet valves, and the containers equipped with such outlet valves or such pumps, comprise different variants, modifications and improvements that will be obvious to a person skilled in the art, it being understood that these different variants, modifications and improvements form part of the scope of the invention as defined by the following claims.

### REFERENCES

Reference 1: U.S. Pat. No. 8,875,953
Reference 2: U.S. Pat. No. 5,186,368
Reference 3: GB1474620

The invention claimed is:

1. A container intended to receive a liquid or viscous substance, said container comprising a wall and an outlet valve, said outlet valve comprising:
a membrane arranged in said wall of the container, the membrane being elastically deformable under the effect of positive pressure of the substance relative to the outside, an outer surface of the membrane being in contact with an external environment, in the area of at least one first slit formed in a substance removal zone, said at least one first slit being suitable for allowing the discharge of a flow of said substance caused by said positive pressure,
at least one first wall configured to be, in the absence of positive pressure of the substance, in contact with an inner surface of the membrane along at least one first contact line arranged on the periphery of the slit, and configured to allow said inner surface of the membrane to move away from at least part of said at least one first wall in the case of positive pressure of the substance, said at least one first contact line forming, in the absence of positive pressure of the substance, at least one first linear sealing zone.

2. The container as claimed in claim 1, wherein said at least one first contact line is a closed line that can surround or otherwise at least a first slit.

3. The container as claimed in claim 1, wherein said at least one first wall comprises an edge in contact with said inner surface of the membrane in the absence of positive pressure of the substance to form said at least one first contact line.

4. The container as claimed in claim 1, wherein said membrane further comprises at least one first protuberance extending from the inner surface of said membrane, said at least one first wall being, in the absence of positive pressure of the substance, in contact with said at least one first protuberance to form said at least one first contact line.

5. The container as claimed in claim 4, wherein said at least one first wall comprises a plate and said at least one first protuberance is substantially toric, in contact with said plate in the absence of positive pressure of the substance.

6. The container as claimed in claim 1, wherein said outlet valve further comprises at least one duct for conveying the substance into a volume in proximity to the inner surface of the membrane, said at least one first wall being formed by one end of said at least one duct for conveying the substance.

7. The container as claimed in claim 4, wherein:
said outlet valve further comprises at least one duct for conveying the substance into a volume in proximity to the inner surface of the membrane, said at least one first wall being formed by one end of said at least one duct for conveying the substance; and
said at least one first protuberance is in the form of a stud, configured to shut off said end of said at least one duct for conveying the substance.

8. The container as claimed in claim 1, comprising a plurality of walls each forming a linear sealing zone.

9. The container as claimed in claim 1, comprising a plurality of slits.

10. The container as claimed in claim 1, further comprising:
a chamber comprising an inner volume suitable for containing the substance, said membrane of the outlet valve forming one wall of the chamber,
an opening allowing the admission into the inner volume of the chamber of a volume of replacement liquid following the cessation of pressing by the user,
the assembly comprising said outlet valve, the chamber, and the opening forming a pump that can be operated by pressing by the user.

11. The container as claimed in claim 10, wherein the chamber comprises a first sub-assembly comprising said outlet valve, a second sub-assembly comprising the opening formed in the chamber, and a channel configured to connect said first and second sub-assemblies.

12. The container as claimed in claim 11, wherein the second sub-assembly is configured to form a pressing zone for a user, the positive pressure of the substance relative to the outside being generated by the user pressing on the pressing zone.

13. The container as claimed in claim 10, further comprising a reservoir of said liquid or viscous substance, said reservoir being fluidically connected to said chamber by means of said opening.
